(19) United States
(12) Patent Application Publication
(10) Pub. No.: US 2015/0373562 A1
(43) Pub. Date: Dec. 24, 2015

(54) UPDATING STORED INFORMATION ABOUT WIRELESS ACCESS POINTS

(71) Applicant: NOKIA TECHNOLOGIES OY, Espoo (FI)

(72) Inventors: Lauri Aarne Johannes WIROLA, Tampere (FI); Laura WIROLA, Tampere (FI)

(21) Appl. No.: 14/764,872

(22) PCT Filed: Feb. 21, 2013
(86) PCT No.: PCT/IB2013/051405

§ 371 Date: Jul. 30, 2015

(51) Int. Cl. H04W 24/02; H04W 48/16

(52) U.S. Cl. CPC H04W 24/02; H04W 48/16

(57) ABSTRACT

An apparatus receives (111) information about at least two wireless access points obtained in a scan at a single location and retrieves (112) information from a record that is stored for a particular one of the at least two wireless access points. The apparatus determines (113) whether to update information about neighboring wireless access points in the record stored for the particular wireless access point by comparing received information with retrieved information. In case (114) it is determined to update information about neighboring wireless access points, the apparatus causes an update of information about neighboring wireless access points in the record stored for the particular access point based on the received information.

### FIELD OF THE DISCLOSURE

The invention relates to stored information about wireless access points, and more specifically to an updating of such information.

### BACKGROUND

Modern global cellular and non-cellular positioning technologies are based on generating large global databases containing information on cellular and non-cellular signals. The information may originate entirely or partially from users of these positioning technologies. This approach is also referred to as “crowd-sourcing”.

The information provided by users is typically in the form of “fingerprints”, which contain a an indication of a position that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points (APs), the service set identifier (SSID) of the access points, and the signal strength of received signals (received signal strength indication RSSI or physical Rx level in dBm with a reference value of 1 mW, etc.).

This data may then be transferred to a server or cloud, where the data may be collected and where further models may be generated based on the data for positioning purposes. Such further models can be coverage area estimates, node positions and/or radio channel models, with base stations of cellular communication networks and access points of WLANs being exemplary nodes. In the end, these refined models may be used for estimating the position of mobile terminals.

Fingerprints do not necessarily have to comprise a GNSS based position. They could also include cellular and/or WLAN measurements only. In this case the fingerprint could be assigned a position for example based on a WLAN based positioning in a server. Such self-positioned fingerprints can be used to learn cellular network information, in case there are cellular measurements in the fingerprint. Moreover, in a set of WLAN measurements in a fingerprint there may be, in addition to measurements for known WLAN access points, also measurements for unknown access points, and the position of the unknown access points can be learned through these self-positioned fingerprints. Finally, more data can be learned for previously known access points based on self-positioned fingerprints.

It may be noted that even when using a mobile terminal having GNSS-capabilities, a user may benefit from using cellular/non-cellular positioning technologies in terms of time-to-first-fix and power consumption. Also, not all applications require a GNSS-based position. Furthermore, cellular/non-cellular positioning technologies work indoors as well, which is generally a challenging environment for GNSS-based technologies.

### SUMMARY OF SOME EMBODIMENTS OF THE INVENTION

A method is described which comprises at an apparatus receiving information about at least two wireless access points obtained in a scan at a single location. The method further comprises retrieving information from a record that is stored for a particular one of the at least two wireless access points. The method further comprises determining whether to update information about neighboring wireless access points in the record stored for the particular wireless access point by comparing received information with retrieved information. The method further comprises, in case it is determined to update information about neighboring wireless access points, causing an update of information about neighboring wireless access points in the record stored for the particular access point based on the received information.

Moreover a first apparatus is described, which comprises means for realizing the actions of the presented method.

The means of the apparatus can be implemented in hardware and/or software. They may comprise for instance at least one processor for executing computer program code for realizing the required functions, at least one memory storing the program code, or both.

Alternatively, they could comprise for instance circuitry that is designed to realize the required functions, for instance implemented in a chipset or a chip, like an integrated circuit. In general, the means may comprise for instance one or more processing means.

Moreover a second apparatus is described, which comprises at least one processor and at least one memory including computer program code, the at least one memory and the computer program code configured to, with the at least one processor, cause at least one apparatus at least to perform the actions of the presented method.

Any of the described apparatuses may be a module or a component for a device, for example a chip. Alternatively, any of the mentioned apparatuses may be a device, for instance a server.

Any of the described apparatuses may further comprise only the indicated components or one or more additional components. For example, any of the apparatuses may optionally comprise in addition a database storing information about access points.

In certain embodiments, the described methods are information providing methods, and the described apparatuses are information providing apparatuses.

In certain embodiments of the described methods, the methods are methods for updating stored information about wireless access points. In certain embodiments of the described apparatuses, the apparatuses are apparatuses for updating stored information about wireless access points.

Moreover, a system is described, which comprises any of the presented apparatuses and at least one other device, for example a database storing records for a plurality of access points, and/or at least one wireless access point, and/or a mobile device configured to perform measurements on wireless access points and to provide information based on the measurements and/or another device providing information about wireless access points, and/or a server using the stored records for supporting a positioning of mobile devices.

Moreover a non-transitory computer readable storage medium is described, in which computer program code is stored. The computer program code causes at least one apparatus to perform the actions of the presented method when executed by at least one processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the respective computer program code by itself has to be considered an embodiment of the invention. The computer program code could also be distributed to several computer readable storage mediums.

Moreover a non-transitory computer readable storage medium is described, which is configured to store data using a predetermined structure, the predetermined structure enabling storage of: identifiers of wireless access points and, linked to a respective identifier, information about a wireless access point identified by the identifier and information about neighboring wireless access points. The computer readable storage medium could be for example a disk or a memory or the like.

It is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an exemplary embodiment of an apparatus;

FIG. 2 is a flow chart illustrating an exemplary embodiment of a method;

FIG. 3 is a schematic block diagram of an exemplary embodiment of a system;

FIG. 4 is a diagram illustrating an exemplary structure that is provided for storing information about wireless access points;

FIG. 5 is a flow chart illustrating an exemplary operation in the system of FIG. 3;

FIG. 6 is a schematic block diagram of an exemplary embodiment of an apparatus;

FIG. 7 is a schematic block diagram of an exemplary embodiment of an apparatus; and

FIG. 8 schematically illustrates exemplary removable storage devices.

### DETAILED DESCRIPTION OF THE FIGURES

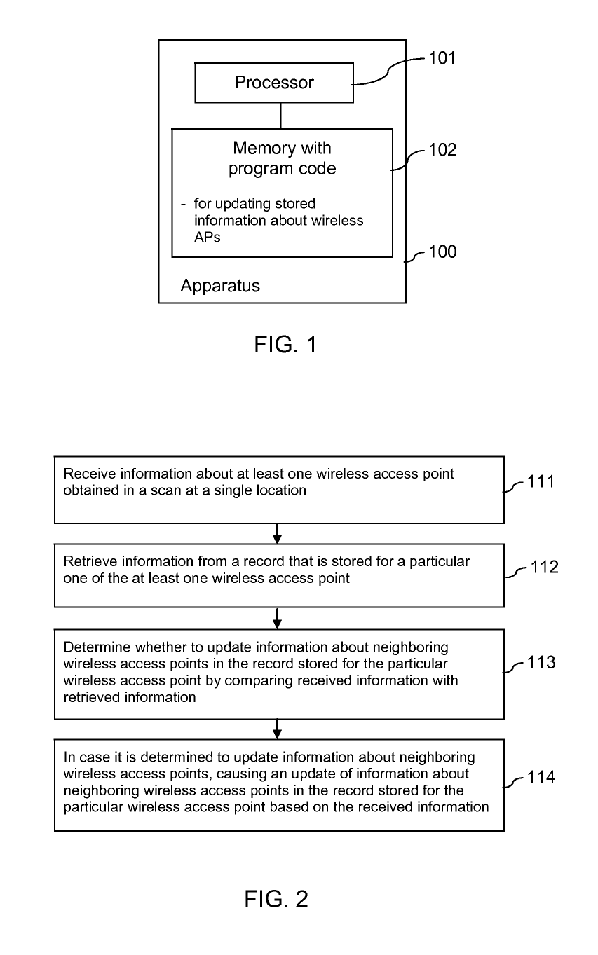

FIG. 1 is a schematic block diagram of an exemplary embodiment of an apparatus. Apparatus 100 comprises a processor 101 and, linked to processor 101, a memory 102. Memory 102 stores computer program code for updating stored information about wireless access points. Processor 101 is configured to execute computer program code stored in memory 102 in order to cause an apparatus to perform desired actions. Memory 102 is thus an exemplary embodiment of a non-transitory computer readable storage medium, in which computer program code is stored.

Apparatus 100 could be a server or any other device. Apparatus 100 could equally be a module, like a chip, circuitry on a chip or a plug-in board, for a server or for any other device. Optionally, apparatus 100 could comprise various other components, like a data interface, a user interface, a further memory, a further processor, etc.

An operation of apparatus 100 will now be described with reference to the flow chart of FIG. 2. The operation is an exemplary embodiment of a method according to the invention. Processor 101 and the program code stored in memory 102 cause an apparatus to perform the operation when the program code is retrieved from memory 102 and executed by processor 101. The apparatus that is caused to perform the operation can be apparatus 100 or some other apparatus, for example but not necessarily a device comprising apparatus 100.

The apparatus receives information about at least two wireless access points obtained in a scan at a single location. (action 111) The at least two wireless access points could comprise a WLAN access point, but equally any other type of wireless access point, like a Bluetooth based access point, etc.

The apparatus retrieves information from a record that is stored for a particular one of the at least two wireless access points. (action 112) The particular wireless access point could be selected based on any desired criterion. It is to be understood that the record could be stored in a memory internal or external to the apparatus.

The apparatus determines whether to update information about neighboring wireless access points in the record stored for the particular wireless access point by comparing received information with retrieved information. (action 113) A wireless access point could be a neighboring wireless access point or neighbor wireless access point for a particular wireless access point, in case there is at least one location at which signals can be detected from this wireless access point and from the particular wireless access point. The expressions “neighboring wireless access point” and “neighbor wireless access point” will be used synonymously in this document. It is to be understood that all or selected parts of the received information could be compared with all or parts of the retrieved information.

The apparatus causes an update of information about neighboring wireless access points in the record stored for the particular access point based on the received information, in case it is determined to update information about neighboring wireless access points. (action 114)

It is to be understood that, optionally, the apparatus may perform actions 112 to 114 for each or some of the access points for which information is received in action 111.

The invention proceeds from the consideration that wireless access points may be moved, even if there are not provided by a mobile device. For example, if companies or private persons using fixed WLAN access points move, they will take their WLAN access points with them so that the location of the WLAN access points changes. Such movements may cause problems for a positioning service that is based on crowd-sourced data. If the stored location information for wireless access points is outdated, using such information may distort the positioning results. When using stored wireless access point based location information for learning the locations of further wireless access points for updating the database, such positioning errors may furthermore cause database corruption.

One way to detect a movement of a wireless access point comprises evaluating the position in position-tagged fingerprints. If fingerprints that are received for a given access point originate first from one location and then from another location, this may indicate a movement of the access point. Of course, the possibility of a positioning error must be taken into account. This means that evidence on the movement of an access point must be collected over time, which reduces the sensitivity of the learning system to movements of access points. This may lead to decreased user experience.

Certain embodiments of the invention therefore provide that stored information about neighboring wireless access points is updated for a particular wireless access point based on an evaluation of received information about the particular wireless access point and possibly about further wireless access point that have been observed at the same location.

Certain embodiments may thus allow taking into account changes of neighboring wireless access points when deciding whether or not a particular wireless access point should be considered to have moved. This may have the effect that a decision on a possible movement of a wireless access point can be taken faster and with an increased reliability.

Certain embodiments may further have the effect that different kinds of messages including information about at least two wireless access points can be taken into account. In a learning/positioning system, information about wireless access points may not only be received in the form of position-tagged fingerprint data for supporting crowd sourcing; a positioning system may also receive a large number of positioning requests for mobile devices that collected information about wireless access points in a respective scan. In a typical scenario, the amount of the positioning requests outnumbers the amount of position-tagged fingerprints by orders of magnitude. These positioning requests do not contain a position that could be evaluated for detecting a movement of a particular wireless access point. However, they contain cellular and/or non-cellular air interface measurements that may be used for updating information about neighboring wireless access points that is stored for a particular wireless access point.

Apparatus 100 illustrated in FIG. 1 and the method illustrated in FIG. 2 may be implemented and refined in various ways.

In an exemplary embodiment, the record supports storage of information about neighboring wireless access points, which comprises an identifier of a neighboring wireless access point. This may have the effect that received information may be mapped easily to stored information using the identifier. An identifier could comprise for example a BSSID or any other suitable identifier, like a MAC address. WLAN access points are identified for instance by a BSSID, and this identifier may be reused in the record. With MAC-48/EUI-48, the BSSID structure may comprise 6 bytes. With EUI-64, the BSSID structure may comprise 8 bytes.

In an exemplary embodiment, the record supports storage of information about neighboring wireless access points, which comprises a respective timestamp for a neighboring wireless access point. Such a timestamp for a particular neighboring wireless access point could indicate the time of the last reported observation of the neighboring wireless access point or the time of the last update of the record with respect to the neighboring wireless access point. Including a timestamp may have the effect that an occasional cleaning up of the stored information on neighboring wireless access points is facilitated. For example, the apparatus could periodically delete all information on neighboring wireless access points that have not been marked as observed for the last year, or any other suitable time span. The timestamp can indicate an absolute time or a time span relative to a reference time. The latter approach may have the effect that the required storage space may be reduced significantly.

In an exemplary embodiment, the record supports storage of information about neighboring wireless access points, which comprises a counter indicating how often information about a neighboring wireless access point has been received and used for an update of stored information. This may have the effect that the reliability of the information about a particular neighboring access point may be determined. A neighboring access point that has been observed many times can be assumed to be a fixed neighboring wireless access point, and not, for instance, a neighboring wireless access point provided by a mobile device supporting tethering or a neighboring wireless access point that has been moved shortly after it was observed first. In case a particular neighboring wireless access point has been observed only once or quite seldom, while most other neighboring wireless access points have been observed many times, the information about the first neighboring wireless access point could also be deleted.

For the case that the retrieved information comprises an indication of a location and the received information comprises an indication of a position, an exemplary embodiment provides that stored information about neighboring wireless access points is updated in case the position indicated in the received information is within a predetermined distance to the location indicated in the retrieved information. Otherwise, no action or only some other action may be performed. When the received indication of position and the stored indication of a location for a particular wireless access point do not match, this may be an indication that the indicated position is an outlier or that the wireless access point has moved. It is to be understood, however, that in certain embodiments there may be situations in which information about neighboring wireless access points is updated even if the position is considered to be an outlier, for example if the retrieved information comprises information about stored neighboring wireless access points and the received information comprises information on a large number of wireless access points corresponding to these neighboring wireless access points.

For the case that the received information does not comprise an indication of a position, an exemplary embodiment provides that stored information about neighboring wireless access points is updated in case the received information comprises information about at least one further wireless access point than the particular wireless access point and the retrieved information comprises information about at least one neighboring wireless access point corresponding to the at least one further wireless access point. Thus, even without an indicated position in the received information, the particular wireless access point can be assumed to be at the same location as before, if there has been information about corresponding neighboring wireless access points before. This may have the effect that stored information may be updated more frequently. It is to be understood that if the received information does not comprise an indication of a position, in certain embodiments stored information about neighboring wireless access points may be updated only in case there is at least one matching neighboring wireless access point or a predetermined number of matching wireless access points. It is further to be understood, however, that in other embodiments other reasons may be defined for updating information about neighboring wireless access points even if the received information does not comprise an indication of a position.

In an exemplary embodiment, causing an updating of stored information about neighboring wireless access points comprises at least one of causing an adding of information on at least one new neighboring wireless access point, and/or causing an updating of a timestamp for at least one neighboring wireless access point, and/or causing an updating of a counter for at least one neighboring wireless access point. In addition to stored information about neighboring wireless access points, other information could be caused to be updated in the record, for instance data on received signal strengths observed for the particular wireless access point and/or data on a coverage area of the particular wireless access point.

In an exemplary embodiment it may thus be determined in addition whether to update other information than information about neighboring wireless access points in the record stored for the particular wireless access point by comparing received information with retrieved information and causing an update of other information in the record stored for the particular wireless access point based on the received information in case it is determined to update other information.

The stored information that is actually updated may be selected depending on various criteria. This may have the effect that a selective updating is enabled. The information that is to be updated could be selected for instance in response to at least one of an existence of an indication of a position in the received information and a trust level of a position indicated in the received information.

The existence of a matching position having a high trust level could lead for example to the most extensive updating. A GNSS based position, for instance, may be highly trustworthy, while a WLAN based position may be less trustworthy. Samples with a highly trustworthy position may be allowed, for instance, to add neighboring access points and to update timestamps and counters for the neighboring wireless access points and to update data for the particular wireless access point, while samples with a less trustworthy position or without position may only be allowed to update timestamps and counters for neighboring wireless access points.

An exemplary embodiment provides that the received information is discarded, in case the retrieved information comprises an indication of a location and the received information comprises an indication of a position that is not within a predetermined distance to the location in the retrieved information and the received information comprises information on at least one further wireless access point than the particular wireless access point that corresponds to retrieved information on at least one neighboring wireless access point. In contrast, an exemplary embodiment provides that an indication that the particular wireless access point is considered to have moved is caused to be stored, in case the retrieved information comprises an indication of a location and the received information comprises an indication of a position that is not within a predetermined distance to the location in the retrieved information and the received information does not comprise information on at least one further wireless access point than the particular wireless access point that corresponds to retrieved information on at least one neighboring wireless access point. This may allow discriminating different kinds of non-matching positions. Received information may simply be discarded, if the indicated position is likely to be an outlier. An indication of a position may be stored, for instance in an existing or newly created outlier grid, if the position is likely to indicate a movement of the particular wireless access point. In this way, the position may be tracked until it is quite certain that there has been a movement. In this case, the indication of the position could be stored as indication of a new location of the particular wireless access point and all other information in the record, except for the identifier of the particular wireless access point, could be deleted. In the meantime, the record could be ignored for positioning purposes.

In an exemplary embodiment, an indication that the particular wireless access point is suspected to have moved is caused to be stored, in case the received information does not comprise an indication of a position and in case the received information does not comprises information on at least one further wireless access point than the particular wireless access point that corresponds to retrieved information on at least one neighboring wireless access point. This may have the effect that those records may be prevented from being used in positioning computations for the time being, either immediately, or only after a lack of overlapping neighboring wireless access points has been determined for a number of times for the same particular wireless access point. On the other hand, such records may not be removed completely, at least not right away, because there may be no overlap simply because the indication of neighboring wireless access points is still incomplete.

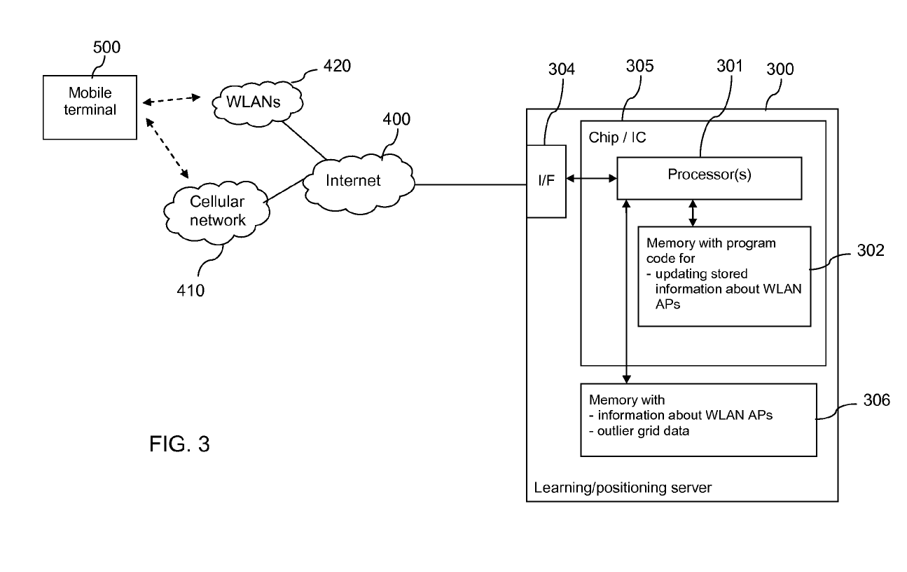

FIG. 3 is a schematic block diagram of an exemplary embodiment of a system, which comprises an apparatus supporting an update of stored information about WLAN access points.

The system comprises a server 300. Server 300 is connected to a network 400, for example the Internet. Server 300 could also belong to network 400. The system comprises in addition a mobile terminal 500. Mobile terminal 500 is able to access network 400 via a cellular network 410 and/or via access points of WLANs 420.

Server 300 may be for instance a positioning server, a position data learning server, or some other kind of server. It comprises a processor 301 that is linked to a first memory 302, to a second memory 306 and to an interface (I/F) 304. Processor 301 is configured to execute computer program code, including computer program code stored in memory 302, in order to cause server 300 to perform desired actions.

Memory 302 stores computer program code for updating stored information about WLAN access points. The computer program code may comprise for example similar program code as memory 102. In addition, memory 302 may store computer program code implemented to realize other functions, for example computer program code for supporting a positioning using the stored data, as well as any kind of other data.

Processor 301 and memory 302 may optionally belong to a chip or an integrated circuit 305, which may comprise in addition various other components, for instance a further processor or memory.

Memory 306 can be accessed by processor 301. It is configured to store data of a positioning database, including information about WLAN access points. In addition, memory 306 could store other data, for instance data for an outlier grid and/or data about cellular base stations. It is to be understood that a memory storing the data could also be external to server 300; it could be for instance on another physical or virtual server.

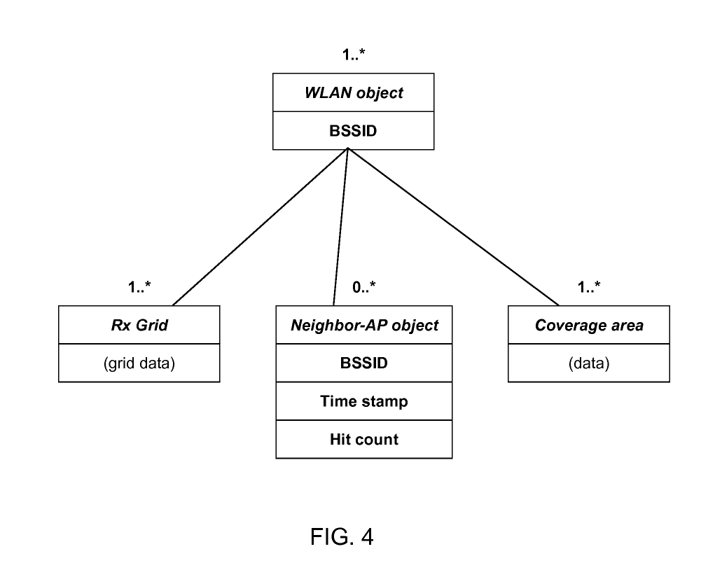

A possible structure provided by the database is illustrated in FIG. 4. A respective record comprises a WLAN object, which is identified by a BSSID of a particular WLAN access point as a primary key. Such a particular WLAN access point can also be referred to as parent WLAN access point. The record further comprises at least one set of Rx grid data and at least one set of coverage area data. Each set of Rx Grid data could comprise for instance an Rx signal level of signals transmitted by the parent WLAN access point that has been measured by a mobile terminal at a position close to a grid point and that has been provided as fingerprint data. The coverage area data may comprise for instance an indication of an assumed location of the WLAN access point, and in addition an indication of a range or a pathloss model. The indication of a location may include the assumed Latitude and Longitude coordinates of the WLAN access point. Several sets of data could be provided for instance in case there are different ranges or different pathloss models for different directions. The coverage area data could be computed and updated based on the stored Rx grid data. The notation “1 . . . *” in FIG. 4 indicates that, in the database, there is at least one WLAN object, at least one set of Rx grid data per object and at least one set of coverage area data per object, the count being unrestricted in each case.

In addition, a record comprises zero, one or more neighbor access point objects, the count being unrestricted. This is indicated by the notation “0 . . . ” in FIG. 4. Each neighbor access point object is identified by an identifier, for instance the BSSID of a neighbor access point that has been observed at least once at the same location as the parent access point. Associated with this BSSID, a field for a timestamp and a field for a hit count are provided. The timestamp indicates when the identified neighbor access point was last observed at the same location as the parent access point. The hit count indicates how often the identified neighbor access point has been observed at the same location as the parent access point since the last reset. In both cases, only those observations are considered that resulted in an update of the record, as will be described in more detail further below. In an exemplary alternative embodiment, a record could be configured to support a maximum of a single neighbor access point object. In this case, the data of the single neighbor access point object could simply comprise a list of identifiers of neighbor access points.

Memory 306 providing a structure as shown in FIG. 4 is an exemplary embodiment of a non-transitory computer readable storage medium, which is configured to store data using a predetermined structure, the predetermined structure enabling storage of identifiers of wireless access points and, linked to a respective identifier, data about a wireless access point identified by the identifier and information about neighboring wireless access points.

Interface 304 is a component which enables server 300 to communicate with other devices, like mobile terminal 500, via network 400. Interface 304 could comprise for instance a TCP/IP socket.

Component 305 or server 300 could correspond to exemplary embodiments of an apparatus according to the invention.

Mobile terminal 500 is configured to scan for WLAN access points and possibly for other types of nodes in its environment. Optionally, mobile terminal 500 could comprise a GNSS receiver, which is configured to compute the position of mobile terminal 500 based on received satellite signals. Mobile terminal 500 is moreover configured to communicate with other devices via a WLAN 420 and/or via a cellular communication network 410.

Cellular communication network 410 could be based on any kind of cellular system, for instance a GSM system, a 3rd Generation Partnership Project (3GPP) based cellular system like a WCDMA system or a TD-SCDMA system, e.g. supporting high speed packet access (HSPA), a 3GPP2 system like a CDMA2000 system, a LTE or LTE-Advanced system, or any other type of cellular system, like a worldwide interoperability for microwave access (WiMAX) system.

Each WLAN 420 comprises at least one access point. To each access point, a BSSID has been assigned.

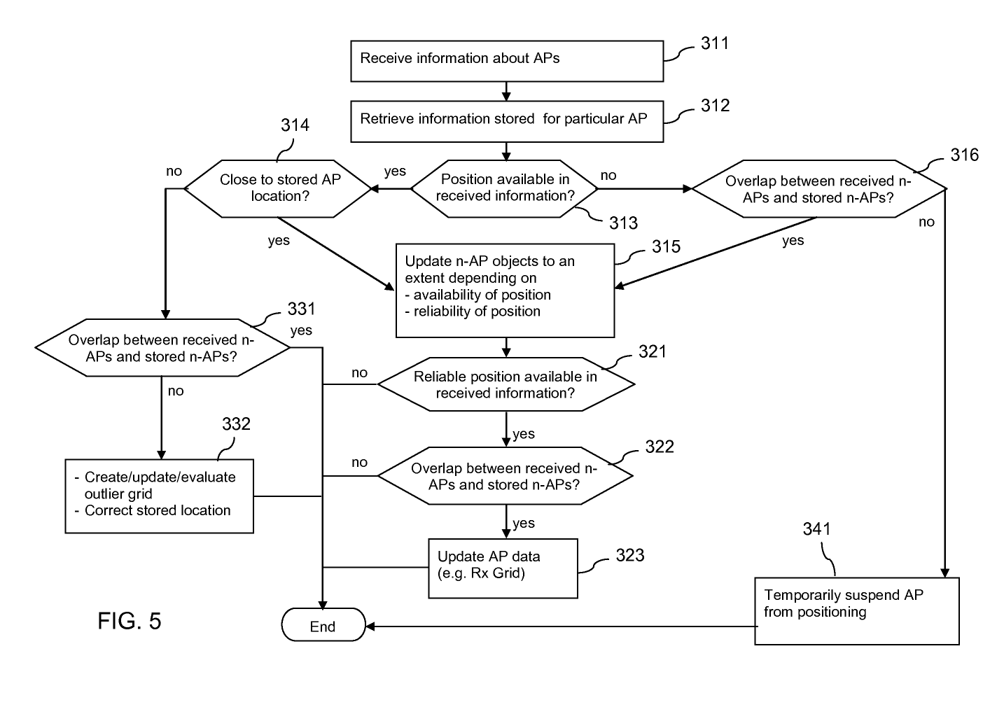

Exemplary operations in the system of FIG. 3 will now be described with reference to FIG. 5.

FIG. 5 is a flow chart illustrating operations at server 300. Processor 301 and some of the program code stored in memory 302 cause server 300 to perform the presented operations when the program code is retrieved from memory 302 and executed by processor 301.

Mobile terminal 500 may be configured to support the collection of learning data for a positioning database. To this end, it may scan the environment at regular intervals for WLAN access points and possibly for base stations of cellular communication networks. At the same time, if possible, it may determine its position using an integrated GNSS receiver. Mobile terminal 500 may assemble results of the scan in a message, optionally along with a GNSS based position, and transmit the message to server 300. Alternatively, mobile terminal 500 may be configured to scan the environment for WLAN access points and possibly for base stations of cellular communication networks whenever the position of mobile terminal 500 is to be determined Mobile terminal 500 may assemble results of the scan in a positioning request and transmit the request to server 300. In both cases, the transmitted results of the scan constitute fingerprint data that may comprise an identifier, for example the BSSID, of all detected access points and auxiliary information, such as an indication of the received signal strength, for one or more of the detected access points.

Server 300 may receive one of these messages including information about WLAN access points from mobile terminal 500. (action 311)

The subsequent actions may be performed separately for each of the access points for which information is included in the received message. The respectively selected access point may be considered to be a parent access point. Alternatively, only one of the access points could be selected as a parent access point. This could be, for instance, the access point with which the strongest observed received signal strength is associated in the received message.

Server 300 retrieves from memory 306 information that is stored for one of the access points that are identified in the received message. (action 312) More specifically, it uses the BSSID of this parent access point to identify a record for the access point, retrieves the BSSIDs of neighboring access points (n-APs) stored in this record, if any, and retrieves an indication of a location from the coverage area data stored in this record.

Server 300 then determines whether a position has been indicated in the received message; that is, whether the received fingerprint data is position-tagged or position-less. (action 313) It is to be understood that retrieval of an indication of a location in action 312 might only be performed after and if it is determined in action 313 that a position has been indicated in the received message.

In case a position has been indicated, server 300 determines whether the indicated position is close to the indicated location. (action 314) The indicated position can be considered to be close to the indicated location in case the distance does not exceed a predetermined threshold value. The predetermined threshold value can be set to a value that is greater than the expected maximum radius of a coverage area of a WLAN access point, for example to 300 m.

In case the indicated position is close to the indicated location, the information in the received message is used to update the stored information. (action 315) More specifically, the existing neighbor access point objects, for which information is included in the received message, are updated by updating the timestamp and by increasing the hit count. If the position has a high trust level and the received message comprises information about a neighbor access point for which no neighbor access point object exists so far in the record, a corresponding neighbor access point object may be added. The position may have a high trust level, for example, if it is indicated in the received message to be a GNSS based position.

In case it is determined in action 313 that no position has been indicated in the received message, server 300 determines whether there is an overlap between the access points, other than the parent access point, for which information is received, on the one hand and the neighbor access points for which neighbor access point objects are included in the record on the other hand. (action 316)

In case there is an overlap, information from the received message is used as well to update the stored information. (action 315) More specifically, the existing neighbor access point objects, for which information is included in the received message, are updated by updating the timestamp and by increasing the hit count. No further updates are performed in this case, though.

Thus, a large percentage of received fingerprints may be used for updating the information about neighbor access points that is stored for a parent access point, not only those that are position tagged with a trustworthy position.

The information in the received message may be subject to further evaluations. Optionally, all or some of these further evaluations may be performed only based on messages that have been received some time after the system started operating or some time after a reset of data, so that a certain number of neighbor access point objects has been created for a large number of WLAN objects.

If a trustworthy position that has been determined to be close to a stored location in action 314 is available in the received message (action 321), server 300 may determine as well whether there is an overlap between the access points, other than the parent access point, for which information is received in action 311, and the neighbor access points for which information was retrieved in action 312. (action 322)

If there is no trustworthy position or if there is no overlap, no further update of the data in the record is performed and the process is ended for the particular parent access point. In this case, it is most likely that not all neighbor access points have been learned yet or that there has been a radical change in the parent access point environment, even though the parent access point itself has not been moved. However, while this likelihood may be sufficient for using the received information for adding neighbor access point data in action 315, it may be preferred not to update the information about the parent access point, like Rx grid data or coverage area data. The reason is that the received position information or the stored location information could also be incorrect, for instance due to a systematic bias,

If there is a trustworthy position and an overlap, the information about the parent access point itself in the record may be updated. (action 323) For instance, the Rx grid data may be supplemented based on Rx level measurements for the parent access point in the received message. The updated Rx grid data could also be used for instance for refining the stored coverage area data for the parent access point.

In case server 300 determines in action 314 that the indicated position is not close to the indicated location, server 300 cannot know for certain yet whether the indicated position can be trusted and the access point has actually moved or whether the indicated position is an outlier. If the access point has moved, the stored indication of the location of the access point should eventually be changed, and the currently stored information should in any case not be used for positioning purposes anymore. If the indicated position is an outlier, the stored indication of the location should not be changed. A wrong decision in favor of one of the possible situations will affect the user experience adversely.

In case server 300 determines in action 314 that the indicated position is not close to the indicated location, server 300 may therefore determine as well whether there is an overlap between the access points, other than the parent access point, for which information is received and the neighbor access points for which neighbor access points objects are included in the record. (action 331).

If there is an overlap, it can be suspected that the position information is incorrect. In this case, the fingerprint data in the received message is neither used for changing the stored indication of a location nor for updating any other stored data. The process may be ended for all access points for which information was received in action 311. Thus, the system is able to discard a fingerprint from the learning process that, without the comparison of neighbor access points, would have led the system to believe that the parent access point has potentially moved.

If server 300 finds no overlap in action 331, this means that neither position nor neighbor access points match stored data and that there is a high probability that the indicated position is not just an outlier but that the parent access point has actually moved. The comparison in action 331 may thus reinforce an assumption that an access point has moved.

In this case, server 300 could create or update and evaluate an outlier grid. The outlier grid data could be stored in memory 306 or in some other memory. The outlier grid can be used for tracking whether further messages indicating essentially the same position have been received for a particular parent access point. If an evaluation of the outlier grid shows that the indicated position for a parent access point has been similar for a predetermined number of recent position-tagged fingerprints, server 300 may change the indicated location in the coverage area data for the parent access point to an indication of a location corresponding, for example, to an average of these indicated similar positions. (action 332) All other data in the record, except for the identifier of the parent WLAN access point, may be deleted. In the meantime, the record for the WLAN access point may not be used in positioning computations. It is to be understood that the evaluation of the outlier grid could also be performed separately from the operation presented in FIG. 5. It could be performed for instance at regular intervals for all access points for which data is stored in the outlier grid.

In case server 300 determines in action 316 that there is no overlap between the access points, other than the parent access point, for which information is received and the neighbor access points for which neighbor access point objects are included in the record, there may have been an incomplete set of neighbor access point objects, or there may have been a radical change in the access point environment, possibly due to a movement of the parent access point. In this case, server 300 may decide to end the process for the particular parent access point, or, as a safety measure, to temporarily suspend the particular parent access point from being used in positioning computations in order to collect further evidence of a movement of the parent access point. (action 341) An indication that a parent access point is temporarily suspended from positioning computations could be stored in the record for the parent access point, for instance in an additional field of the WLAN object (not shown in FIG. 4). If later on, there is no further evidence of a movement of the parent access point, the record for the access point may be returned to a status in which it is usable again for positioning computations. It is to be understood that alternatively to storing an indication that a parent access point is temporarily suspended from positioning computations in the record for the parent access point, identifications of temporarily suspended access points could be stored separately in memory 306.

Possible actions in an exemplary embodiment can thus be summarized with the following table:

| | Matching | Non-matching | No position in |
|---|---|---|---|
| | position | position | received information |
| Overlap between | Update n-AP | Discard | Update n-AP |
| received and | objects (and | received | objects |
| stored n-APs | other AP data) | information | |
| No overlap | Update n-AP | Add AP to | Temporarily |
| | objects | outlier grid/ | suspend |
| | | update AP | AP data from |
| | | location | positioning |

It is to be understood that if the information about access points received in action 311 belongs to a positioning request of mobile terminal 500, the stored and updated information about WLAN access points in memory 306 may be used for determining the position of mobile terminal 500. The determined position may then be provided to mobile terminal 500 or to any apparatus that generated the request for the position of mobile terminal 500.

It is further to be understood that updating any information—within a record stored for a particular wireless access point or external to the record stored for the particular wireless access point—depending on the result of a comparison of received information about neighboring wireless access points with information about neighboring wireless access points retrieved from the record stored for the particular wireless access point is also an aspect of the invention by itself, irrespective of how the retrieved information about neighboring wireless access points is generated and updated.

Certain embodiments of the invention may thus allow detecting position outliers utilizing position-tagged fingerprints and gathering evidence on a movement of an access point using both position-tagged and position-less fingerprints. Using position-tagged learning data and position-less positioning requests to assist in the movement detection ensures that an increased amount of information is available, which may make the detection faster and more reliable. A fast and reliable detection of position outliers on the one hand and of moved wireless access points on the other hand may be suited to improve the accuracy of a positioning service and as a result the user experience. In addition, the burden for database updates is reduced, if fingerprints with incorrect position information can be neglected.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory (ROM), a random access memory (RAM), a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

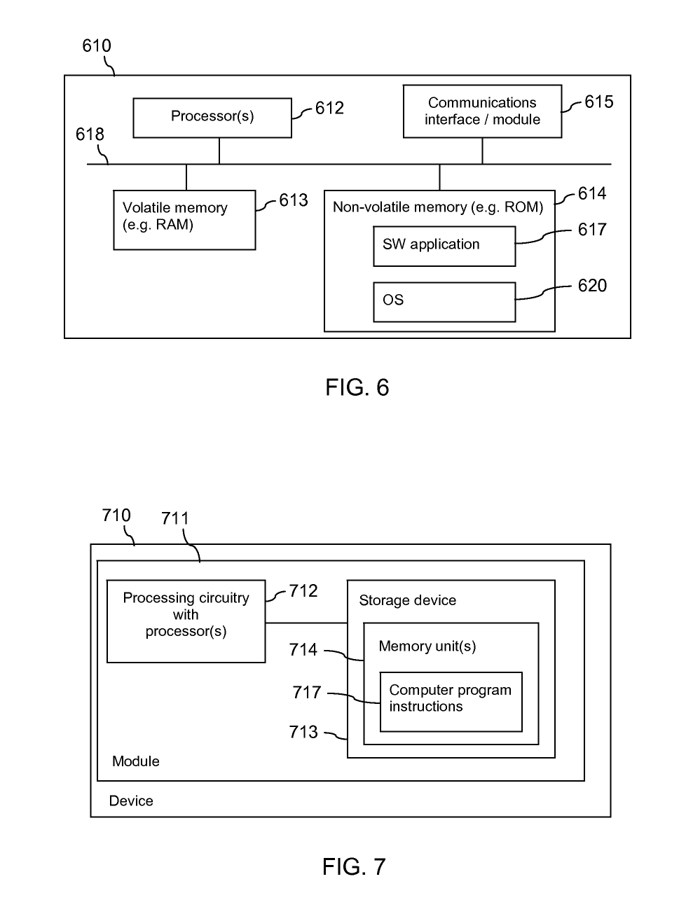

Exemplary embodiments using at least one processor and at least one memory as a non-transitory data medium are shown in FIGS. 6 and 7.

FIG. 6 is a schematic block diagram of a device 610. Device 610 includes a processor 612. Processor 612 is connected to a volatile memory 613, such as a RAM, by a bus 618. Bus 618 also connects processor 612 and RAM 613 to a non-volatile memory 614, such as a ROM. A communications interface or module 615 is coupled to bus 618, and thus also to processor 612 and memories 613, 614. Within ROM 614 is stored a software (SW) application 617. Software application 617 may be a navigation application, although it may take some other form as well. An operating system (OS) 620 also is stored in ROM 614.

FIG. 7 is a schematic block diagram of a device 710. Device 710 may take any suitable form. Generally speaking, device 710 may comprise processing circuitry 712, including one or more processors, and a storage device 713 comprising a single memory unit or a plurality of memory units 714. Storage device 713 may store computer program instructions that, when loaded into processing circuitry 712, control the operation of device 710. Generally speaking, also a module 711 of device 710 may comprise processing circuitry 712, including one or more processors, and storage device 713 comprising a single memory unit or a plurality of memory units 714. Storage device 713 may store computer program instructions that, when loaded into processing circuitry 712, control the operation of module 711.

The software application 617 of FIG. 6 and the computer program instructions 717 of FIG. 7, respectively, may correspond e.g. to the computer program code in memory 102 or memory 302.

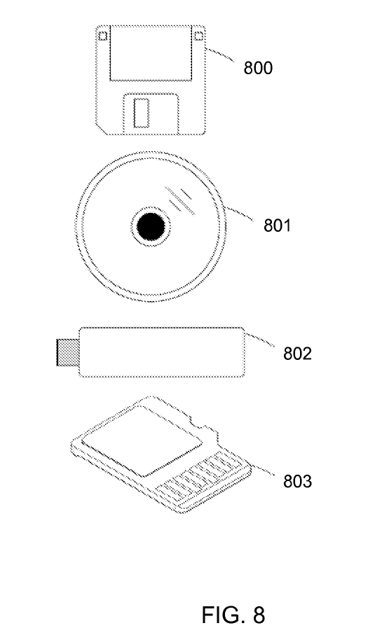

In exemplary embodiments, any non-transitory computer readable medium mentioned in this text could also be a removable/portable storage or a part of a removable/portable storage instead of an integrated storage. Exemplary embodiments of such a removable storage are illustrated in FIG. 8, which presents, from top to bottom, schematic diagrams of a magnetic disc storage 800, of an optical disc storage 801, of a semiconductor memory circuit device storage 802 and of a Micro-SD semiconductor memory card storage 803.

The functions illustrated by processor 101 in combination with memory 102, by processor 301 in combination with memory 302, or by the integrated circuit 305 can also be viewed as means for receiving information about at least two wireless access points obtained in a scan at a single location; means for retrieving information from a record that is stored for a particular one of the at least two wireless access points; means for determining whether to update information about neighboring wireless access points in the record stored for the particular wireless access point by comparing received information with retrieved information; and means for causing an update of information about neighboring wireless access points in the record stored for the particular access point based on the received information, in case it is determined to update information about neighboring wireless access points.

The program codes in memories 102 and 302 can also be viewed as comprising such means in the form of functional modules.

FIGS. 2 and 5 may also be understood to represent exemplary functional blocks of computer program codes supporting an update of stored information about wireless access points.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-23. (canceled)

24. An apparatus comprising at least one processor and at least one memory including computer program code, the at least one memory and the computer program code configured to, with the at least one processor, cause at least one apparatus at least to perform:
receive information about at least two wireless access points obtained in a scan at a single location;
retrieve information from a record that is stored for a particular one of the at least two wireless access points;
determine whether to update information about neighboring wireless access points in the record stored for the particular wireless access point by comparing received information with retrieved information; and
cause an update of information about neighboring wireless access points in the record stored for the particular access point based on the received information, in case it is determined to update information about neighboring wireless access points.

25. The apparatus according to claim 24, wherein the record supports storage of information about neighboring wireless access points comprising at least one of:
an identifier of a neighboring wireless access point;
a timestamp for a neighboring wireless access point; and
a counter indicating how often information about a neighboring wireless access point has been received and used for an update of stored information.

26. The apparatus according to claim 24, wherein for the case that the retrieved information comprises an indication of a location and that the received information comprises an indication of a position, the computer program code is configured to, with the at least one processor, cause the at least one apparatus to update stored information about neighboring wireless access points in case the position indicated in the received information is within a predetermined distance to the location indicated in the retrieved information.

27. The apparatus according to claim 24, wherein the computer program code is configured to, with the at least one processor, cause the at least one apparatus, in case the received information does not comprise an indication of a position, to update stored information about neighboring wireless access points in case the received information comprises information about at least one further access point than the particular access point and the retrieved information comprises information about at least one neighboring wireless access point corresponding to the at least one further access point.

28. The apparatus according to claim 24, wherein causing an updating of stored information about neighboring wireless access points comprises at least one of causing an adding of information about at least one new neighboring wireless access point;
causing an updating of a timestamp for at least one neighboring wireless access point; and
causing an updating of a counter for at least one neighboring wireless access point,
and wherein the computer program code is configured to, with the at least one processor, cause the at least one apparatus to select the information that is to be updated in response to at least one of:
an existence of an indication of a position in the received information; and
a trust level of a position indicated in the received information.

29. The apparatus according to claim 24, wherein the computer program code is configured to, with the at least one processor, cause the at least one apparatus to;
determine whether to update other information than information about neighboring wireless access points in the record stored for the particular wireless access point by comparing received information with retrieved information; and
cause an update of the other information in the record stored for the particular wireless access point based on the received information, in case it is determined to update other stored information.

30. The apparatus according to claim 24, wherein for the case that the retrieved information comprises an indication of a location and that the received information comprises an indication of a position that is not within a predetermined distance to the location indicated in the retrieved information, the computer program code is configured to, with the at least one processor, cause the at least one apparatus to perform at least one of the following:
in case the received information comprises information about at least one further wireless access point than the particular access point that corresponds to retrieved information about at least one neighboring wireless access point, discard the received information; and
in case the received information does not comprise information about at least one further wireless access point than the particular access point that corresponds to retrieved information about at least one neighboring wireless access point, cause storage of an indication that the particular access point is considered to have moved.

31. The apparatus according to claim 24, wherein for the case that the received information does not comprise an indication of a position, the computer program code is configured to, with the at least one processor, cause the at least one apparatus to perform the following:
in case the received information does not comprises information about at least one further wireless access point than the particular access point that corresponds to retrieved information about at least one neighboring wireless access point, cause storage of an indication that the particular wireless access point is suspected to have moved.

32. The apparatus according to claim 24, wherein the apparatus is one of:
a server; and
a component for a server.

33. A system comprising the apparatus according to claim 32 and at least one of:
a database storing records for a plurality of access points;
at least one wireless access point;
a mobile device configured to perform measurements on wireless access points and to provide information based on the measurements; and
a server using the stored records for supporting a positioning of mobile devices.

34. A method comprising at an apparatus:
receiving information about at least two wireless access points obtained in a scan at a single location;
retrieving information from a record that is stored for a particular one of the at least two wireless access points;
determining whether to update information about neighboring wireless access points in the record stored for the particular wireless access point by comparing received information with retrieved information; and
in case it is determined to update information about neighboring wireless access points, causing an update of information about neighboring wireless access points in the record stored for the particular access point based on the received information.

35. A computer program code, the computer program code when executed by a processor causing at least one apparatus to perform the actions of the method of claim 34.

36. A non-transitory computer readable storage medium in which computer program code is stored, the computer program code when executed by a processor causing at least one apparatus to perform the following:
receive information about at least two wireless access points obtained in a scan at a single location;
retrieve information from a record that is stored for a particular one of the at least two wireless access points;
determine whether to update information about neighboring wireless access points in the record stored for the particular wireless access point by comparing received information with retrieved information; and
cause an update of information about neighboring wireless access points in the record stored for the particular access point based on the received information, in case it is determined to update information about neighboring wireless access points.

37. A non-transitory computer readable storage medium configured to store data using a predetermined structure, the predetermined structure enabling storage of:
identifiers of wireless access points and, linked to a respective identifier:
information about a wireless access point identified by the identifier; and
information about neighboring wireless access points.
